(19) United States
(12) Patent Application Publication
(10) Pub. No.: US 2024/0306755 A1
(43) Pub. Date: Sep. 19, 2024

(54) OPTIMIZED PLASTIC HELMET SHELL STRUCTURE

(71) Applicant: CHANG-HSIEN HO, TAINAN CITY (TW)

(72) Inventor: CHANG-HSIEN HO, TAINAN CITY (TW)

(21) Appl. No.: 18/674,077

(22) Filed: May 24, 2024

Related U.S. Application Data
(63) Continuation-in-part of application No. 17/069,086, filed on Oct. 13, 2020, now abandoned.

(30) Foreign Application Priority Data
Jul. 16, 2020 (TW) 109124135

(51) Int. Cl. A42B 3/06; B29C 70/34

(52) U.S. Cl. CPC A42B 3/06; B29C 70/34

(57) ABSTRACT

An optimized plastic helmet shell structure includes a preform made of a composite material produced from at least one fiber layer attached to an outer surface of a thin sheet shell consisting of at least one piece of thin sheet plastic material. The preform is hot formed in a forming module to form a helmet-shaped shell assembly. During the hot forming, the thin sheet shell has at least a part of its surface structure combined with or permeated into the fiber layer and the fiber layer is stretched on along the outer surface of the thin sheet shell into a tensed state. Therefore, the whole helmet-shaped shell assembly has reinforced but thin and light structure, and the fiber layer is smoothly and fitly attached to the outer surface of the shell assembly and can be colorized or printed with patterns.

### FIELD OF THE INVENTION

The present invention patent application is a continuation-in-part (CIP) of U.S. patent application Ser. No. 17/069,086, the content of which is hereby incorporated by reference. The present invention relates to an optimized plastic helmet shell structure, and more particularly, to a thin helmet shell including a fiber layer with good hydrophilicity, i.e. a highly hydrophilic fabric layer, which is laminated to a thin and flat sheet of plastic material to form a thin sheet preform in advance and then the preform undergoes thermoforming and stamping to provide a helmet-shaped shell, and the fiber layer is composited with the shell to form a smooth and fitly attached outer surface structure of the shell.

### BACKGROUND OF THE INVENTION

It is a known skill to use a plastic or a fiberglass shell along with impact-resistant filler made of a thermal foaming material to manufacture a safety helmet structure, of which the plastic shell tightly wraps around and bonds to the foaming filler material. The helmet can be used in different ball games, riding sports, dangerous working sites to provide necessary protection to the wearer. U.S. Pat. No. 4,466,138 entitled “Safety helmet with a shell injected from thermoplastics and method for the manufacture of said helmet”; Taiwan Patent application Ser. No. 85/101,810 entitled “Method of manufacturing safety helmet”; U.S. Pat. No. 5,018,220 entitled “Firefighter's helmet”, etc. have disclosed some typical examples of safety helmets and methods of manufacturing safety helmets.

The safety helmet with the above structure, i.e. having a plastic or a fiberglass shell, is designed mainly to resist a collision with an external object, to resist a breaking down impact, or to provide a heat-resistant ability. In the event of an external impact, the foaming filler could buffer the impact force or disperse while transmit the impact force to thereby provide the effect of protecting the wearer's head.

Another important purpose of manufacturing the helmet with a plastic or fiberglass shell is to give the safety helmet a good quality, an attractive appearance, or a highly distinguishable design. A user would normally like to have rich colors or printed patterns shown on the outer surface of the safety helmet. However, either the plastic or the fiberglass helmet shell has the material characteristics of not easily colorized or printed to show patterns thereon. Currently, to enable the forming of colors or patterns on the outer surface of the plastic or fiberglass helmet shell, multiple pieces (such as 6 to 8 pieces) of patterned layers (stickers) are applied to or glued onto the outer side of the plastic or fiberglass helmet shell, or different fabric materials are attached to the outer side of the plastic or fiberglass helmet shell. To overcome the disadvantages of the plastic and fiberglass helmet shell that they are not easily colorized or printed to show patterns and the colors or patterns provided thereon are easily peeled off, the currently available practice is to paint and glue patterned layers or to attach highly hydrophilic fabrics on the outer surface or predetermined locations of the plastic or fiberglass helmet shell after the plastic or fiberglass helmet shell is formed. As can be found by a person of ordinary skill in the art, the above conventional helmet shell structure has the following shortcomings:

(1) The gluing of the patterned layers or fabric materials to the helmet shell requires an experienced and skilled operator. Since the outer surface of the helmet shell has a curved profile while the patterned layers and fabric materials are planar, wrinkles and creases tend to occur on the planar patterned layers or fabric materials when they are attached to the curved outer surface of the helmet shell, particularly when the operator is inexperienced. And, the creased condition particularly easily occurs on the helmet shell near the rim thereof.

This is because the operator instinctively pushes the patterned layers or fabric materials when gluing or attaching them to the helmet shell, so that the whole patterned layers or fabric materials, particularly the most important areas thereof, can be smoothly glued or attached to the outer surface of the helmet shell. As a result, peripheral portions of the patterned layers or fabric materials farther away from the top of the helmet shell would become surplus, protruded, and could not be aligned with the configuration of the plastic or fiberglass helmet shell at the rim thereof to form creases.

The above condition of forming creases is particularly obvious in the case elastic stickers or fabric materials are used. The operator has to spend additional time to trim or adjust the stickers or fabric materials and tends to damage the previously finished patterned layers in the process of trimming the surplus and creased portions. The trimming and adjustment is obviously a difficult operation to largely increase the manufacturing time and labor cost.

(2) According to the conventional helmet shell manufacturing method, to avoid the condition of having protruded edges of the patterned layers or fabric materials or unable for the edges of the patterned layers or fabric materials to align with or to be located at correct positions on the profile of the helmet shell, the patterned layers or fabric materials are specifically sized for them to match the predetermined areas on the plastic helmet shell as much as possible. However, it is often difficult to control the size of the elastic patterned layers or fabric materials. Therefore, the produced helmet shells tend to have non-uniform appearances.

(3) In the case the gluing operation is handled by a not sufficiently experienced operator, the frequency of occurring squeezed or creased edges or partial areas of the patterned layers or fabric materials, particularly in the gluing process, would obviously increased; and the condition of having smudge of glue attached to other areas of the helmet shell is also increased.

Presently, the operation of gluing the patterned layers or fabric materials is relied on a large number of labors instead of being performed in mass and accurately using machines. This indicates the helmet production must, although relatively difficult, develop from a labor-intensive industry requiring a large amount of labor to a technology-intensive industry that does not require a large number of skilled and experienced operators, in order to reduce the overall production time and cost of the helmet shell. Therefore, it is very uneasy to control the quality of produced helmet shells.

Generally speaking, the above references reflect that the current safety helmet structural design and manufacture are not ideal. It is therefore desirable to redesign the helmet by taking the component structure of the helmet into account to make the helmet structurally different from the conventional helmet and be manufactured and processed in different ways to avoid the shortcomings in the conventional helmet. Some of the important issues in relation to the improvement of helmet manufacturing are as follows:

(1) The helmet should be designed to have a component structure different from the conventional helmet while satisfying the requirement for safety in use, and the helmet can be manufactured with simple steps and is thin and light in weight.

(2) The helmet shell manufacturing method should be able to eliminate the conditions of having edges of patterned layers or fabric materials protruded from or not aligned with the profile of the plastic helmet shell, so as to improve the problems of unsmooth joints between the patterned layers or fabric materials and the helmet profile, time consuming processing or manufacturing steps, requirement for a large amount of skilled operators, and high yield loss.

(3) Particularly, it is desirable that fiber layers, such as the patterned layers or fabric materials, can be provided on the outer surface of the helmet shell in a tensed state, so that the helmet shell can provide a degree of elastic reaction or rebounding force in the event of an external impact against the helmet and accordingly, reduce the possible injury to the wearer's head by the external impact.

### SUMMARY OF THE INVENTION

A primary object of the present invention is to provide an optimized plastic helmet shell structure, which can be manufactured through a method involving some relatively simple steps.

In a first step (A), at least one highly hydrophilic fiber layer and at least one thin sheet material are provided; the thin sheet material may be selected from plastics, fine fibers of glass, polycarbonate (PC), or other similar materials and formed into a thin sheet structure.

In a second step (B), the fiber layer is coated on the thin sheet material to provide a preform.

In a third step (C), a first forming module is provided and the preform is hot pressed in the first forming module to form a helmet-shaped shell assembly. During the hot pressing, a thin sheet shell formed by the thin sheet material has at least a part of its surface structure combined with or permeated into the fiber layer, so that a bonding state is formed between the thin sheet shell and the fiber layer; and the fiber layer in the forming operation is pushed and stretched into a tensed state and coated on an outer surface of the thin sheet shell.

According to a preferred embodiment of the present invention, the method of manufacturing optimized plastic helmet shell structure further includes a fourth step (D) after the third step (C). In the fourth step (D), the shell assembly is provided at an inner side with a foaming material and then put in a second forming module, such that the foaming material is foamed to provide an elastic structure filling up and bonding to the inner side of the shell assembly to make up an integral part of the helmet shell structure, making the helmet shell structure reinforced, thin in volume, and light in weight while the fiber layer is smoothly attached to the outer surface of the helmet shell structure and can be printed with colorful patterns.

A helmet shell structure manufactured according to the above method includes a thin sheet shell and a highly hydrophilic fiber layer attached to an outer surface of the thin sheet shell, and the fiber layer can be colorized or printed with patterns. The thin sheet shell has at least a part of its outer surface structure combined with or permeated into the fiber layer to form a bonding state between them, and the fiber layer in the forming operation is stretched along the outer surface and outer profile of the thin sheet shell into a tensed state to tightly and fitly attach to the outer surface of the thin sheet shell. With this structure, the shell assembly can generate an elastic reaction or exert an elastic rebound when it is subjected to a collision with an external impact and accordingly, reduce possible injury to a wearer's head.

### BRIEF DESCRIPTION OF THE DRAWINGS

FIG. 1 shows a highly hydrophilic fiber layer and a thin sheet material are used in a first step (A) of a method for forming an optimized plastic helmet shell structure according to the present invention;

FIG. 2 shows the highly hydrophilic fiber layer is laminated to the thin sheet material to provide a preform in a second step (B) of the method;

FIG. 3 shows a third step (C) of the method, in which the preform including a thin sheet shell formed of one piece of thin sheet material and a fiber layer located on an outer side of the thin sheet shell is shaped in a first forming module to form a shell assembly having a helmet shape or profile;

FIG. 3A shows another embodiment of the third step (C) of the optimized helmet shell structure manufacturing method, in which a preform including a thin sheet shell formed of a plural piece of thin sheet materials and a plurality of fiber layers located on an outer side of the thin sheet shell is shaped in the first forming module to form a shell assembly having a helmet shape or profile;

FIG. 4 is a structural plan view showing the thin sheet shell of the shell assembly has its surface structure combined with or permeated into the fiber layer;

FIG. 5 shows a fourth step (D) of the optimized helmet shell structure manufacturing method, in which the shell assembly and a foaming material are shaped in a second forming module to form the helmet shell structure of the present invention;

FIG. 6 is an example of the helmet shell structure of the present invention in use, showing the helmet shell structure is subjected to an external impact force (i.e. a normal impact force); and

FIG. 7 is another example of the helmet shell structure of the present invention in use, showing the helmet shell structure is subjected to an oblique impact force or a shearing force.

### DETAILED DESCRIPTION OF THE PREFERRED EMBODIMENTS

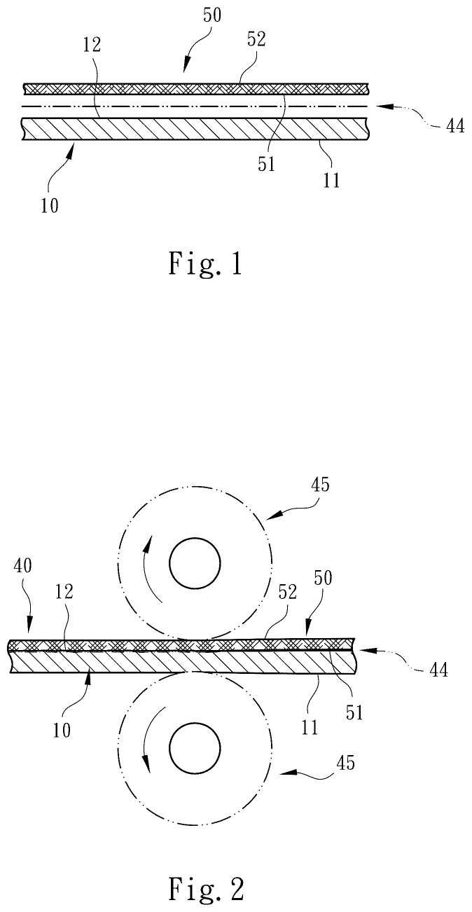

Please refer to FIG. 1. To explain a method of manufacturing a reinforced plastic safety helmet shell, a helmet for sports and work activities is described herein as an embodiment of the present invention. The helmet can be one used in American football, hockey, construction site, mountain climbing, horse racing, bicycle or motorcycle riding, car racing, etc., and can be a half-shell helmet or a full-face helmet.

In this specification, the directional terms, such as upper, top, lower, bottom, outer side and inner side, respectively indicate a direction in relation to a reference direction as shown in the drawings. For example, one side of a part of the helmet facing toward the wearer is defined as a first side, an inner side, or interior; and an opposite side of the same part facing away or located farther away from the wearer is defined as a second side, an outer side, or exterior.

Please refer to FIGS. 1, 2 and 3, in which the steps included in the method of manufacturing the safety helmet according to the present invention are pictorially described.

In a first step (A), at least one highly hydrophilic fiber layer 50 and at least one thin sheet material 10 are provided. Herein, the fiber layer 50 may be selected from the group consisting of highly hydrophilic cloth, fabric, and other similar products for use as an embodiment of the present invention. The thin sheet material 10 may be selectively a plastic material, fine fibers of glass, polycarbonate (PC), or other similar materials combining a single or a plurality of thin sheet assembling units for forming a whole thin sheet structure.

As shown, the fiber layer 50 defines or has a first side 51 and a second side 52, and the thin sheet material 10 defines or has a first side 11 and a second side 12. In a feasible embodiment, a full sheet of large size fiber layer 50 can be formed by connecting a plurality of assembling units of fiber layers together.

In a second step (B), an assembling operation is performed, such that the highly hydrophilic fiber layer 50 or the first side 51 thereof is attached to the thin sheet material 10 or the second side 12 thereof to provide a preform 40.

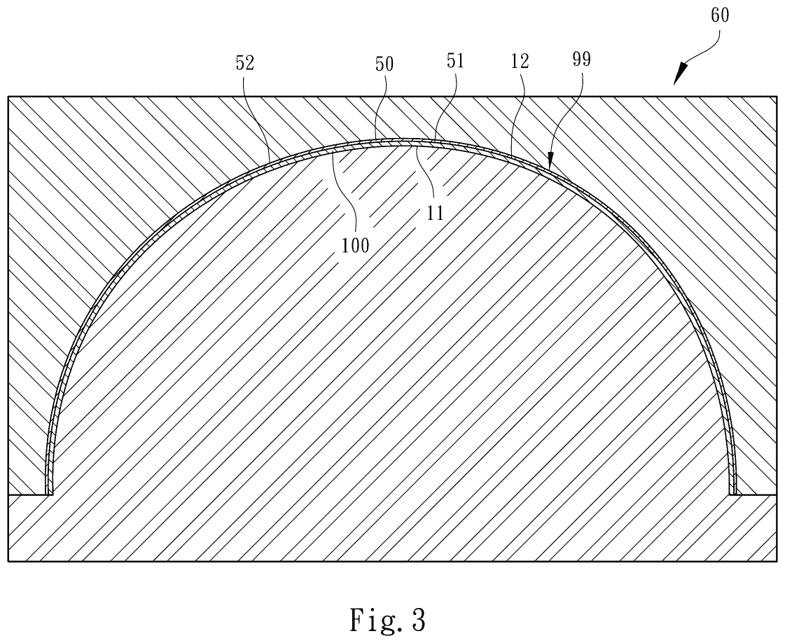

In a feasible embodiment, the phantom lines in FIG. 2 indicate the thin sheet material 10 and the fiber layer 50 attached thereto are together moved through a pressing module 45, such as two rollers, to be hot pressed to facilitate the attachment of the fiber layer 50 to the thin sheet material 10. Alternatively, an adhesive layer 44 (indicated by phantom lines in FIG. 2) is applied to between the first side 51 of the fiber layer 50 and the second side 12 of the thin sheet material 10 to enhance the attachment of the fiber layer 50 to the thin sheet material 10.

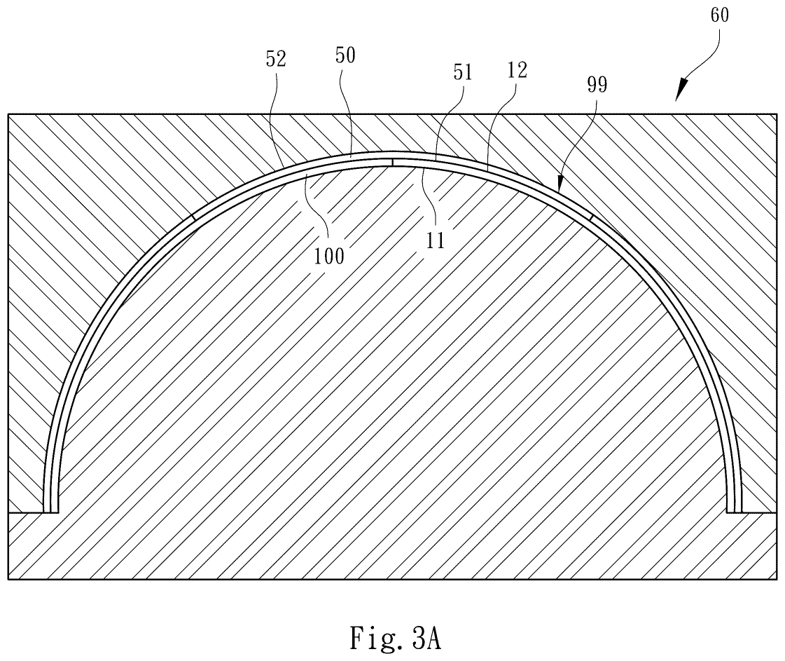

Please refer to FIG. 3. In a third step (C), a forming operation is performed, in which a first forming module 60 is provided for hot forming the preform 40, which includes a thin sheet shell 100 formed of one piece of the thin sheet material 10 and a fiber layer 50 located on an outer side of the thin sheet shell 100, such that the preform 40 is formed into a helmet-shaped shell assembly 99, and the fiber layer 50 is coated on an outer surface of the shell assembly 99 to form a protection layer. In another embodiment of the third step (C) as shown in FIG. 3A, a preform 40 including a thin sheet shell 100 formed of a plural piece of thin sheet materials 10 and a plurality of fiber layers 50 located on an outer side of the thin sheet shell 100 are hot formed using the first forming module 60 to form the helmet-shaped shell assembly 99. Since the fiber layer 50 is highly hydrophilic, a variety of patterns and/or characters can be printed on the fiber layer 50 as decorations.

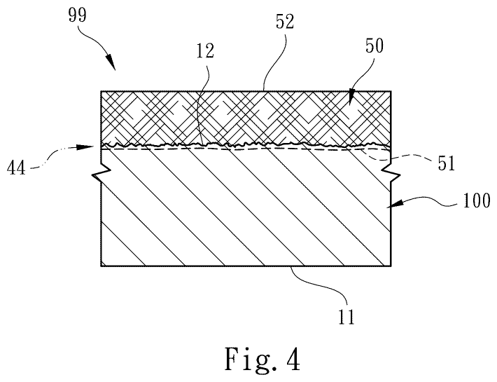

Please refer to FIG. 4. The shell assembly 99 formed in the third step (C) consists of a thin sheet shell 100 formed of the thin sheet material 10. At least a part of the surface structure of the thin sheet shell 100 or the second side 12 thereof is combined with or permeated into the fiber layer 50 to form a bonded state between the fiber layer 50 and the thin sheet shell 100. When the partial structure at the surface (i.e. the second side) of the thin sheet shell 100 is bonded to the fiber layer 50, the fiber layer 50 is on the one hand pushed by the gradually formed thin sheet shell 100 and on the other hand stretched by the downward pressed first forming module 60. As a result, the structure of the fiber layer 50 is in a constantly tensed state to be stretched or coated over the second side 12 or the outer profile of the thin sheet shell 100. The tensed and stretched fiber layer 50 generates an outward anti-resistance when the thin sheet shell 100 is subjected to an external impact and pulls the shell outward. Particularly, in the third step (C), when the fiber layer 50 is stretched into a tensed state or tightened state along the thin sheet shell 100, the fiber layer 50 would not loosen to produce wrinkles or creases to thereby overcome the disadvantage in the conventional helmet forming method that the fabric is not stretched to fitly attach to the shell and produces creases. Besides, the method of manufacturing the helmet according to the present invention requires generally reduced processing time compared to the conventional manually operation and can therefore save a large amount of time and labor.

It is noted the combination of the fiber layer 50 and the thin sheet shell 100 disclosed in the above embodiment advantageously creates some complementary effects in the structural and binding strength between the fiber layer 50 and the thin sheet shell 100. First, the helmet made of the combination of the thin sheet shell 100 and the fiber layer 50 has a largely reduced thickness and weight. In one example, the thin sheet shell 100 can be made of a non-film sheet material 10 as thin as 0.5 mm to 2.0 mm. Second, in the step of forming a composite material by hot pressing the fiber layer 50 and the thin sheet material 10 at the same time, it is able to effectively eliminate the problem of forming wrinkles and creases in the fiber layer. Third, the fiber layer 50 is highly hydrophilic, which allows subsequent coloring or printing or painting on the outer surface of the fully formed shell assembly 99 to overcome the problem of the conventional helmet shell as uneasy to print colorful patterns.

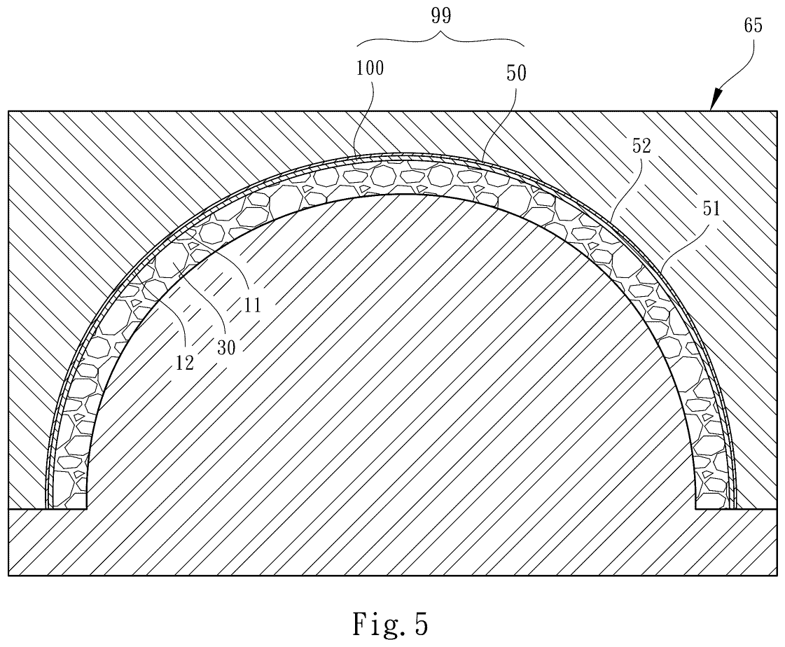

Please refer to FIG. 5. In a fourth step (D) of the method of manufacturing the optimized helmet shell structure, a foaming material binding operation is performed to provide a solid-state foaming material on an inner side of the shell assembly 99. A second forming module 65 is heated for the foaming material to foam and form an elastic structure 30 providing a buffering effect, which fills up and connects to the shell assembly 99 to together construct a helmet structure that meets the required overall structural strength while has light weight and overcomes the problems of complicated and time-consuming processing procedures in the conventional helmet structure manufacturing method.

The helmet structure manufactured according to the above method of the present invention includes a combination of a thin sheet shell 100 and a fiber layer 50 located at an outer side or a second side 12 of the thin sheet shell 100. The thin sheet shell 100 has at least a part of its surface structure, or its structure at the second side 12, being combined with or permeated into the structure of the fiber layer 50 to form the above-mentioned bonding state. In the bonding state, the fiber layer 50 is pushed and stretched on the outer surface or the profile of the thin sheet shell 100 in the forming operation to become tensed. The fiber layer 50 in the tensed state presents an elastic reaction to an external force or pulls the thin sheet shell 100 to rebound elastically outward in response to the external force, and avoids the forming of creases when being coated on the thin sheet shell 100.

In a modified embodiment, a foaming material is provided on the first side 11 or the inner side of the thin sheet shell 100 to form the elastic structure 30 to complete the helmet shell structure of the present invention.

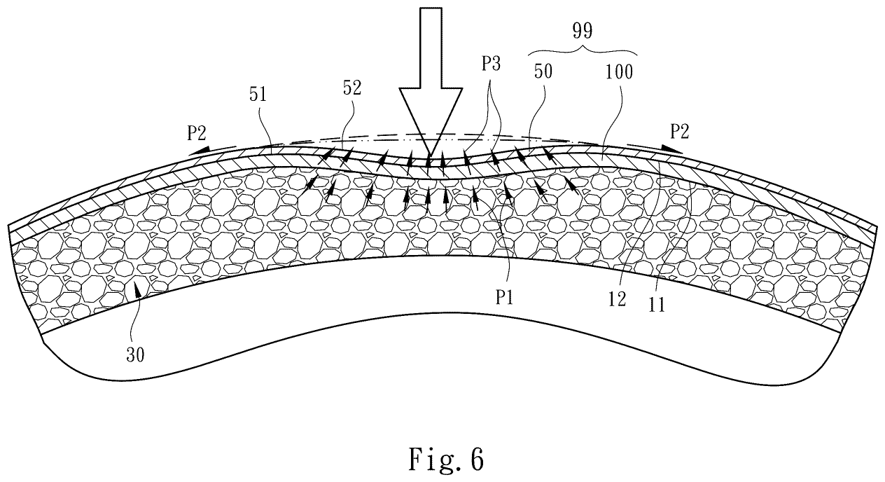

Please refer to FIG. 6. When the shell assembly 99 or the helmet shell structure is subjected to an external normal impact force, the thin sheet shell 100, the elastic structure 30, and/or the fiber layer 50 are respectively deformed elastically by different degrees to thereby reduce the speed of the external impact force. That is, the thin sheet shell 100, the elastic structure 30, and/or the fiber layer 50 together bear the external impact force to provide a buffering and absorbing effect, such that the external impact force is dispersed and transmitted to the entire shell assembly 99 or the helmet shell structure to prevent the external impact force from penetrating the shell assembly 99 or helmet shell structure and accordingly, effectively alleviate or reduce injury to the wearer's brain.

When the external impact force disappears, an outward push force (P₁) exerted by the elastic structure 30 and/or an elastic tension force (P₂+P₃) exerted by the fiber layer 50 together provide the thin sheet shell 100 with a structural property of enhanced rebounding force outward, enabling the shell assembly 99 to restore to its original configuration as much as possible.

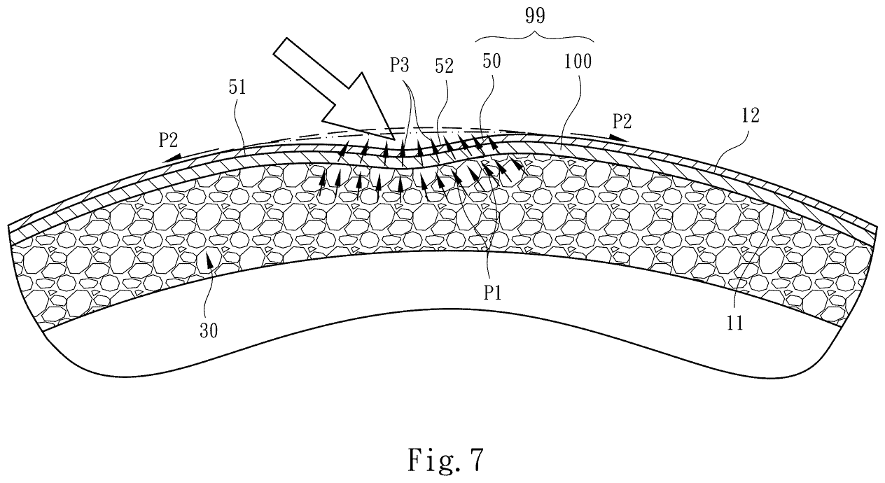

Please refer to FIG. 7. When the shell assembly 99 or the helmet shell structure is subjected to an external oblique impact force (i.e. a shearing force), the thin sheet shell 100, the elastic structure 30, and/or the fiber layer 50 are respectively deformed elastically by different degrees to together bear the external impact force to provide a buffering and absorbing effect, which reduces a displacement motion caused by a rotational acceleration or a side direction rotating force of the external oblique impact force (including a low-gravity rotational impact force), such that the impact force is dispersed and transmitted to the entire shell assembly 99 or the helmet shell structure to buffer and absorb the impact force. Thus, the acceleration and torque exerted by the external impact force is reduced to effectively alleviate or lower possible injury to the wearer's brain.

And, when the external oblique impact force disappears, the outward push force (P₁) exerted by the elastic structure 30 and/or an elastic tension force (P₂+P₃) exerted by the fiber layer 50 together provide the thin sheet shell 100 with a structural property of enhanced outward rebound, enabling the shell assembly 99 to restore to its original configuration as much as possible.

Compared to the conventional plastic safety helmet shell structure, the shell assembly 99 combining the thin sheet shell 100 and the fiber layer 50 not only advantageously gives the thin sheet shell 100 increased elasticity, but also gives the thin sheet shell 100, the elastic structure 30 and/or the shell assembly 99 higher structural strength to bear the external compact force.

Generally speaking, compared to the conventional method of manufacturing plastic helmet shell, the method of manufacturing optimized plastic safety helmet shell and the optimized plastic helmet shell structure so manufactured according to the present invention further take the following designs into consideration and include the following advantages:

(1) The thin sheet shell 100, the fiber layer 50, and/or the elastic structure 30 are combined to form the shell assembly 99. In the first to third steps (A), (B), (C), and/or the fourth step (D), the fiber layer 50 and the thin sheet shell 100 are combined stably in easy and convenient procedures to form the preform 40, which not only changes the conventional ways of manufacturing and processing the helmet shell, but also facilitates the subsequent procedures to complete the helmet shell structure, creating an optimized plastic helmet shell structure obviously different from the conventional helmet shell structure.

(2) The thin sheet shell 100 has at least part of its structure combined with or permeated into the structure of the fiber layer 50, and the fiber layer 50 is pushed and stretched on along the outer side or the profile of the thin sheet shell 100 into a tensed state during the forming step (C). The fiber layer 50 in the tensed state presents an elastic reaction to an external force or pulls the thin sheet shell 100 to rebound elastically outward. Therefore, the shell assembly 99 not only has ideal structural strength, but also can be manufactured in simplified procedures to be thin and light in design. Further, the fiber layer 50 and the thin sheet shell 100 advantageously creates a complementary effect in the structurally binding strength between them, which obviously reduces the thickness, weight and volume of the helmet shell structure.

(3) Specifically, in the shell assembly 99 provided by the present invention, the fiber layer 50 is highly hydrophilic to provide good colorizing or printing property, such that the condition of protruded or misaligned edges of the printed patterns or fabric on the plastic helmet shell profile is minimized. The disadvantageous conditions, such as unsmooth joints between the helmet shell profile and the printed patterns or fabrics, the forming of creases on the printed patterns and fabrics, time and labor consuming processing procedures, requiring skilled workers, high yield loss, and high material cost, are also largely improved.

Therefore, the present invention provides an effective method of manufacturing reinforced plastic helmet shell, and the helmet shell structure manufactured using the method of the present invention has spatial pattern different from that of the conventional helmet shell structures and provides a lot of incomparable advantages, making the present invention improved to satisfy the requirement for granting a patent.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An optimized plastic helmet shell structure, comprising:
a thin sheet shell (100) and a highly hydrophilic fiber layer (50), which are hot pressed to produce a composite material with the fiber layer (50) attached to an outer side of the thin sheet shell (100) for forming a shell assembly (99); and
the thin sheet shell (100) having at least a part of its surface structure combined with or permeated into the fiber layer (50) to form a bonding state between the thin sheet shell (100) and the fiber layer (50); and the fiber layer (50) being pushed and stretched on along the outer side of the thin sheet shell (100) into a tensed state when the fiber layer (50) is hot pressed to integrate with the thin sheet shell (100).

2. The optimized plastic helmet shell structure as claimed in claim 1, further comprising an elastic structure (30) formed of a foaming material and provided on an inner side of the thin sheet shell (100) to make up an integral part of the helmet shell structure.

3. The optimized plastic helmet shell structure as claimed in claim 1, wherein the thin sheet shell (100) is formed of a whole piece of thin sheet material (10) consisting of and assembled from a plurality of thin sheet assembling units; and the fiber layer (50) is in the form of a whole sheet of fiber layer consisting of a plurality of fiber layer assembling units connected to one another.

4. The optimized plastic helmet shell structure as claimed in claim 2, wherein the thin sheet shell (100) is formed of a whole piece of thin sheet material (10) consisting of and assembled from a plurality of thin sheet assembling units; and the fiber layer (50) is in the form of a whole sheet of fiber layer consisting of a plurality of fiber layer assembling units connected to one another.

5. The optimized plastic helmet shell structure as claimed in claim 1, wherein the composite material produced from the thin sheet shell (100) and the fiber layer (50) includes at least one fiber layer (50) coated on at least one piece of thin sheet material (10) to provide a preform (40), and the preform (40) being hot formed in a first forming module (60) to form a shell assembly (99); and the at least one piece of thin sheet material (10) in the shell assembly (99) forming the thin sheet shell (100), which has at least a part of its outer surface structure combined with or permeated into the fiber layer (50) to form the bonding state between the thin sheet shell (100) and the fiber layer (50).

6. The optimized plastic helmet shell structure as claimed in claim 2, wherein the composite material produced from the thin sheet shell (100) and the fiber layer (50) includes at least one fiber layer (50) coated on at least one piece of thin sheet material (10) to provide a preform (40), and the preform (40) being hot formed in a first forming module (60) to form a shell assembly (99); and the at least one piece of thin sheet material (10) in the shell assembly (99) forming the thin sheet shell (100), which has at least a part of its outer surface structure combined with or permeated into the fiber layer (50) to form the bonding state between the thin sheet shell (100) and the fiber layer (50).

7. The optimized plastic helmet shell structure as claimed in claim 5, wherein the fiber layer (50) is coated on the thin sheet material (10) in a way selected from the group consisting of hot pressing the fiber layer (50) and the thin sheet material (10) together using a pressing module (45) and applying an adhesive layer (44) between the fiber layer (50) and the thin sheet material (10).

8. The optimized plastic helmet shell structure as claimed in claim 6, wherein the fiber layer (50) is coated on the thin sheet material (10) in a way selected from the group consisting of hot pressing the fiber layer (50) and the thin sheet material (10) together using a pressing module (45) and applying an adhesive layer (44) between the fiber layer (50) and the thin sheet material (10).

9. The optimized plastic helmet shell structure as claimed in claim 3, wherein the composite material produced from the thin sheet shell (100) and the fiber layer (50) includes at least one fiber layer (50) coated on at least one piece of thin sheet material (10) to provide a preform (40), and the preform (40) being hot formed in a first forming module (60) to form a shell assembly (99); and the at least one piece of thin sheet material (10) in the shell assembly (99) forming the thin sheet shell (100), which has at least a part of its outer surface structure combined with or permeated into the fiber layer (50) to form the bonding state between the thin sheet shell (100) and the fiber layer (50).

10. The optimized plastic helmet shell structure as claimed in claim 4, wherein the composite material produced from the thin sheet shell (100) and the fiber layer (50) includes at least one fiber layer (50) coated on at least one piece of thin sheet material (10) to provide a preform (40), and the preform (40) being hot formed in a first forming module (60) to form a shell assembly (99); and the at least one piece of thin sheet material (10) in the shell assembly (99) forming the thin sheet shell (100), which has at least a part of its outer surface structure combined with or permeated into the fiber layer (50) to form the bonding state between the thin sheet shell (100) and the fiber layer (50).

11. The optimized plastic helmet shell structure as claimed in claim 9, wherein the composite material produced from the thin sheet shell (100) and the fiber layer (50) includes at least one fiber layer (50) coated on at least one piece of thin sheet material (10) to provide a preform (40), and the preform (40) being hot formed in a first forming module (60) to form a shell assembly (99); and the at least one piece of thin sheet material (10) in the shell assembly (99) forming the thin sheet shell (100), which has at least a part of its outer surface structure combined with or permeated into the fiber layer (50) to form the bonding state between the thin sheet shell (100) and the fiber layer (50).

12. The optimized plastic helmet shell structure as claimed in claim 10, wherein the composite material produced from the thin sheet shell (100) and the fiber layer (50) includes at least one fiber layer (50) coated on at least one piece of thin sheet material (10) to provide a preform (40), and the preform (40) being hot formed in a first forming module (60) to form a shell assembly (99); and the at least one piece of thin sheet material (10) in the shell assembly (99) forming the thin sheet shell (100), which has at least a part of its outer surface structure combined with or permeated into the fiber layer (50) to form the bonding state between the thin sheet shell (100) and the fiber layer (50).

13. The optimized plastic helmet shell structure as claimed in claim 1, wherein the fiber layer (50) is pushed, stretched and expanded on and along the outer surface of the thin sheet shell (100) during the process of hot forming, such that the thin sheet shell (100) has its partial surface structure combined with or permeated into the fiber layer (50) to further expand the fiber layer (50), rendering the expanded fiber layer (50) into a tensed state to tightly and fitly attach to the outer surface of the thin sheet shell (100).

14. The optimized plastic helmet shell structure as claimed in claim 2, wherein the fiber layer (50) is pushed, stretched and expanded on and along the outer surface of the thin sheet shell (100) during the process of hot forming, such that the thin sheet shell (100) has its partial surface structure combined with or permeated into the fiber layer (50) to further expand the fiber layer (50), rendering the expanded fiber layer (50) into a tensed state to tightly and fitly attach to the outer surface of the thin sheet shell (100).

15. The optimized plastic helmet shell structure as claimed in claim 3, wherein the fiber layer (50) is pushed, stretched and expanded on and along the outer surface of the thin sheet shell (100) during the process of hot forming, such that the thin sheet shell (100) has its partial surface structure combined with or permeated into the fiber layer (50) to further expand the fiber layer (50), rendering the expanded fiber layer (50) into a tensed state to tightly and fitly attach to the outer surface of the thin sheet shell (100).

16. The optimized plastic helmet shell structure as claimed in claim 4, wherein the fiber layer (50) is pushed, stretched and expanded on and along the outer surface of the thin sheet shell (100) during the process of hot forming, such that the thin sheet shell (100) has its partial surface structure combined with or permeated into the fiber layer (50) to further expand the fiber layer (50), rendering the expanded fiber layer (50) into a tensed state to tightly and fitly attach to the outer surface of the thin sheet shell (100).
